(19) United States
(12) Patent Application Publication
(10) Pub. No.: US 2025/0246206 A1
(43) Pub. Date: Jul. 31, 2025

(54) AI-ENHANCED VIDEO EDITING WITH INTERMEDIATE DATA MODEL REPRESENTATION AND WEB-BASED INTERFACE

(71) Applicant: JobPixel Inc., San Francisco, CA (US)

(72) Inventors: Anthony Duerr, San Francisco, CA (US); Leonardo Kaio Vitali, Cascavel (BR); Eduardo Sára Pereira, Vila Velha (BR); Rafael Fideles Da Silva, Vila Velha (BR)

(21) Appl. No.: 18/429,179

(22) Filed: Jan. 31, 2024

(51) Int. Cl. G11B 27/031; G06F 40/40

(52) U.S. Cl. CPC G11B 27/031; G06F 40/40

(57) ABSTRACT

The present invention relates to a computer-implemented method and system for generating a video editing project using artificial intelligence (AI) and machine learning (ML) techniques. The method includes processing a collection of video clips to generate text-based metadata, receiving selection criteria to identify relevant video clips, and generating a natural language prompt based on the selection criteria. The prompt, comprising instructions and context, is provided to a large language model (LLM), which processes the input and outputs data for constructing a video project data model. The project data model includes timing data for salient snippets within the selected video clips. A dynamic and interactive web-based user interface is rendered to visually represent the project data model, offering a timeline view and editing tools for refining the video project. This system streamlines the video editing process by integrating AI-driven content analysis with user-directed editing, resulting in a tailored video project that aligns with user-defined thematic elements.

### TECHNICAL FIELD

The present application relates to the technical fields of multimedia content analysis and video editing. More specifically, the present application describes methods and systems for utilizing generative artificial intelligence (AI), for example, such as generative language models or large language models (LLMs), in the analysis of multimedia assets, particularly video clips, and in the creation of an intermediate video project data model for video editing projects, which can be refined and manipulated through a web-based video editing interface.

### BACKGROUND

In recent years, the digital landscape has seen an explosion in video content creation, fueled by the widespread availability of mobile computing devices with video recording capabilities and platforms for sharing multimedia content, including video. This proliferation has led to an ever-increasing repository of video footage, necessitating efficient and sophisticated methods for organizing, searching, and editing this content. State-of-the-art video capture devices now offer high-resolution imaging, enhanced stabilization, and a variety of shooting modes, enabling both amateurs and professionals to produce quality video footage with ease. Concurrently, video editing software has evolved to incorporate a range of features such as multi-track editing, special effects, and color correction, allowing for the transformation of raw video clips into professional looking and cinematic productions.

### BRIEF DESCRIPTION OF THE DRAWINGS

Embodiments of the present invention are illustrated by way of example and not limitation in the figures of the accompanying drawings, in which:

FIG. 1 is a system architecture diagram illustrating an example of the various component parts that comprise an online video service, consistent with some examples.

FIG. 2 is a diagram illustrating a video pre-processor for use in pre-processing video clips in a collection of video clips, for the purpose of generating meta-data for use in creating a video editing project, consistent with some examples.

FIG. 3 is a diagram illustrating the relationship between a video clip or file, and the metadata that is generated for the video clip by the video pre-processor, according to some examples.

FIG. 4. is a diagram illustrating the interaction between an artificial intelligence (AI) and machine learning (ML) service that is a component of the online video service, with an external large language model (LLM) integration service, consistent with some examples.

FIG. 5 is a diagram illustrating how a project data model builder processes the output from an LLM to generate a video project data model for a video editing project, according to some examples.

FIG. 6 is a user interface diagram illustrating an example of a web-based video editing application for an online video service, displaying a web-based visual representation of the video project data model as generated by the video online service, consistent with some examples.

FIG. 7 is a flow diagram illustrating the method operations of a computer-implemented method for generating a recommendation for presentation to a user, where the recommendation specifies a topic, a theme, subject matter, or narrative, around which a selection of video clips can be analyzed for purposes of creating a highlight reel or thematic video, consistent with some examples.

FIG. 8 is a flow diagram illustrating the method operations of a computer-implemented method for generating a video editing project, consistent with some examples.

FIG. 9 is a diagram illustrating a software architecture, which can be installed on and utilized with any of a variety of computing devices to perform methods consistent with those described herein.

FIG. 10 illustrates a diagrammatic representation of a machine in the form of a computer system (e.g., a server computer or client computer) within which a set of instructions may be executed for causing the machine to perform any one or more of the methodologies described herein, consistent with some examples.

### DETAILED DESCRIPTION

The present disclosure relates to methods and systems for generating a video project data model for a video editing project, leveraging machine learning and artificial intelligence techniques for the selection and arrangement of video snippets obtained from select video clips in a collection of video clips. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

The proliferation of mobile computing devices equipped with high-quality cameras has revolutionized the way individuals create and share content. With the advent of smartphones and portable video recording devices, people now have the ability to capture life's moments and create video clips with unprecedented ease. This has led to a surge in video content generation, with users eager to share their experiences on social media platforms, personal blogs, company websites, and other digital outlets. The convenience of having a camera always at the ready has democratized content creation, allowing anyone to document and broadcast their narrative to a global audience.

As the volume of video content continues to grow exponentially, content creators and editors are faced with the daunting task of comprehending and managing vast collections of video clips. No single individual can fully appreciate or understand the entirety of content expressed across a large collection of video clips, which often results in a significant challenge: the inability to conceptualize appropriate topics, themes, or subject matter around which a group or selection of video clips can be analyzed for the creation of a highlight reel or thematic video. This problem is exacerbated when the goal is to distill the essence of a large video library into a cohesive narrative or to extract the most impactful moments for storytelling purposes. The overwhelming quantity of footage makes it nearly impossible to manually identify and organize video clips and snippets (i.e., portions of video clips) around central ideas, leading to missed opportunities for content utilization and the potential for compelling narratives to remain undiscovered within the depths of the video archive.

Even when a content creator has a specific theme, topic, subject matter, or narrative in mind, identifying the appropriate video clips and snippets within a voluminous collection is a challenging and time-consuming endeavor. For example, content creators, including video editors, marketers, and social media influencers, often encounter significant challenges when attempting to locate and utilize relevant video clips for their projects. The sheer volume of available content can be overwhelming, making it difficult to sift through hours of footage to find the most salient and pertinent video clips. This task is further complicated by the need to not only identify the best video clips but also to pinpoint the exact moments within those video clips that best convey the intended message or story. The time and effort required to manually review and select these moments can be substantial, detracting from the creative process and delaying project timelines.

In response to this challenge, various online services have emerged, offering to alleviate the burden by manually curating and editing video content. Some platforms have begun to employ artificial intelligence techniques to automate the video creation process, promising to deliver polished videos with minimal human intervention. Many of these AI-driven services are limited as they are designed for analyzing a single video clip, identifying one or more snippets within that individual video clip, and subsequently creating a condensed version of the longer video clip that includes only the relevant snippets, extracted from the sole video clip. Consequently, the output from these services is typically a singular, finalized video clip, which presents the distilled essence of the original content without the option for further modification or refinement.

Because these automated systems typically generate a final product in the form of a completed video clip or file, this presents a significant limitation. The lack of an intermediate, editable format means that any revisions or refinements to the AI-generated video necessitate additional editing work. Users who wish to make changes must import the final video into a separate editing application, effectively starting from scratch in terms of locating and manipulating additional relevant video clips and snippets. This process not only negates the time savings offered by AI automation but also restricts the user's creative control over the final product, as the opportunity for iterative improvement and customization is lost once the AI has rendered its output. There is a clear need for a solution that bridges the gap between AI-assisted content curation and user-directed video editing, providing a more seamless and flexible workflow for video content creation.

Consistent with some embodiments of the present invention, an online video service provides a platform to generate a visual representation of a video project data model by orchestrating the selection and arrangement of video snippets obtained from video clips in a comprehensive collection or library of video clips. Upon receiving user-specified content selection criteria, the online video service processes the selection criteria to identify video clips satisfying the selection criteria, and to formulate a text-based prompt for use as input to a generative language model, such as an LLM. The text-based prompt includes an instruction, derived from the user-specified content selection criteria, as well as text-based metadata associated with each video clip that satisfies the content selection criteria. Accordingly, the instruction provided to the LLM via the prompt instructs the LLM to analyze the metadata of the selected video clips, which is included as context with the prompt, to identify snippets that are relevant to the selection criteria. The output of the LLM is then used as input to a video project data model builder to build or construct a video project data model that includes data representing the relevant snippets from the various video clips. The video project data model is further processed to render a visual representation of the data model in an interactive, web-based user interface that provides for further manipulation and editing of the video project.

The video project data model constructed by the video project data model builder of the online video service encapsulates a structured representation of the video project, including data references to the original video clips that contain the highest-ranking snippets identified by the output from the generative language model, or LLM. Each snippet within the data model is associated with precise timing information, specifying the in and out points within the video clip to ensure accurate extraction and placement within the project timeline. The project data model builder may also integrate additional components such as video transitions, audio tracks, audio sound effects, overlay graphics, text annotations, and other multimedia elements that contribute to the storytelling and aesthetic appeal of the final video project data model, and ultimately, the final video. This integration is achieved through a non-destructive editing process, commonly referred to as non-linear editing, which preserves the integrity of the original video clips. The original media files remain intact and unaltered, allowing for reversible edits and ensuring that the source content is not compromised during the user's creative process.

The inventive system not only enhances the creative capabilities of users but also presents technical advantages that optimize the utilization of system resources. The ability for users to engage in an iterative editing process within the web-based user interface before rendering the final video is a significant departure from conventional AI-based video creation services, which typically output a finished video file with limited options for further editing and modification. This pre-rendering editing process allows users to make precise adjustments and decisions about the content and structure of the video project without the need for resource-intensive rendering operations after each change. Rendering is a hardware-intensive step, often requiring significant processing power and time, especially for high-resolution video content. By enabling users to finalize the content and arrangement of video snippets before initiating the rendering process, the inventive system ensures that rendering resources are utilized efficiently, only when the video project has reached its final form. This approach reduces the computational load on the system, minimizes unnecessary rendering iterations, and leads to a more streamlined production workflow, ultimately saving time and processing power. The result is a system that not only empowers users with greater creative control but also operates with enhanced technical efficiency.

In a second aspect, consistent with some embodiments, the online video service enhances the user experience by not only facilitating the creation of video projects but also by providing the ability to leverage a generative language model in the analysis of a video library to generate recommendations for themes, topics, narratives, and other creative directions. This recommendation engine operates by analyzing the metadata associated with a selection of video clips, which may be curated based on user-specified content selection criteria. Leveraging the metadata of the selected video clips—which includes textual descriptions, timing data, and potentially other content analysis metrics—the system generates a text-based prompt to be provided as input to an LLM. The prompt encapsulates both an instruction and the relevant metadata associated with the selection of video clips, as context. The instruction, which may be defined by the system, directs the LLM to analyze the metadata associated with the selected video clips and suggest one or more themes, topics, subject matters, or narrative ideas. These suggestions are aimed at guiding the user in creating a highlight reel or thematic video that resonates with their intended message or audience. In some embodiments, the system goes a step further by formulating one or more LLM prompts based on the recommendations, which can then be directly used with the integrated LLM service to generate a video project data model referencing the relevant video clips and snippets that best embody the recommended creative direction.

The recommendation system of the online video service not only streamlines the creative process but also offers technical advantages over conventional video creation systems. Traditional systems often rely on the iterative and manual input of creative directions, which can be resource-intensive and inefficient, particularly when users are working with extensive video libraries. In contrast, the online video service's automated generation of creative recommendations represents a more efficient use of system resources. By analyzing the metadata associated with video clips, the system can quickly and accurately identify potential themes and narratives without the need for repeated user input and guesswork. This data-driven approach minimizes the computational overhead that would otherwise be spent on processing numerous user-generated prompts that may not yield relevant results. Furthermore, by providing targeted recommendations based on the content's inherent characteristics, the system ensures that processing power is focused on the most promising creative directions, optimizing resource allocation and reducing the time required to arrive at a compelling video project concept. This technical efficiency, coupled with the cognitive benefits for users, makes the recommendation system a powerful tool for enhancing both the creative and technical aspects of video project development. Other aspects and advantages of the various embodiments of the invention will be apparent from the description of the various figures that follows.

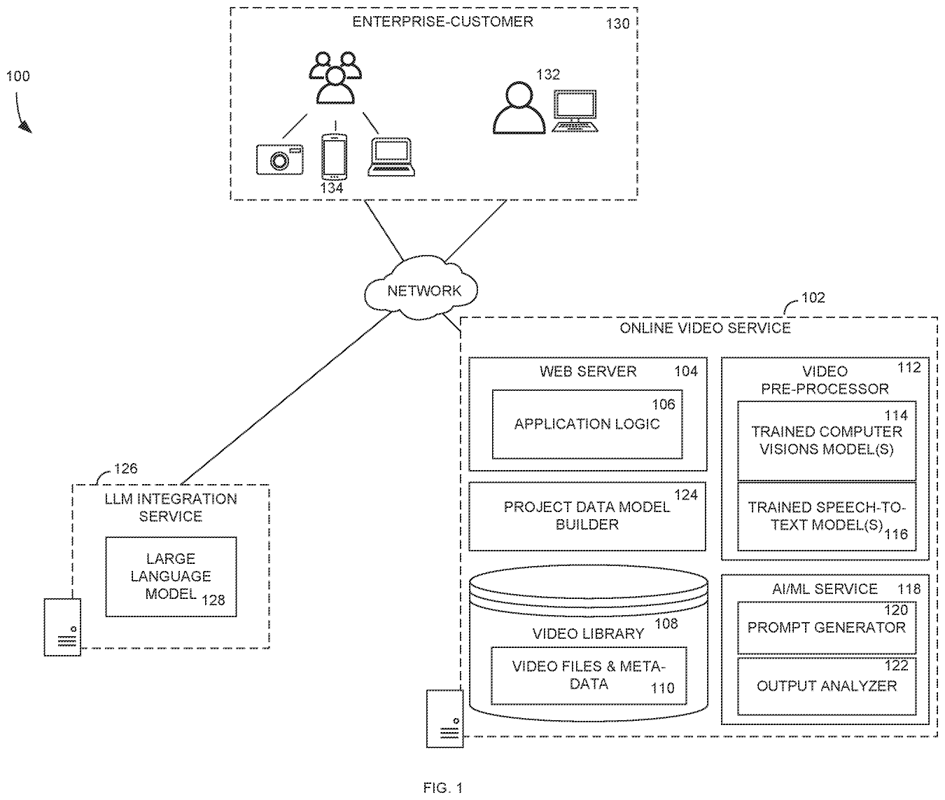

FIG. 1 is a system architecture diagram illustrating an example of the various component parts that comprise an online video service 102, according to some examples. As illustrated in FIG. 1, the online video service 102 includes a web server 104, which hosts the application logic 106 responsible for orchestrating the overall functionality of the service or platform. The video library 108 serves as a repository for the video clips or video files and associated metadata 110, providing a structured database for the storage and retrieval of multimedia content. The video pre-processor 112 includes one or more trained computer vision models 114 and one or more trained speech-to-text models 116, which are utilized to analyze video content and generate metadata for the video clips, such as textual descriptions of visual elements identified within the individual images (frames) of the video clips, and transcribed audio. An AI/ML service 118 is integrated within the online video service 102 and includes a prompt generator 120 for creating tailored prompts to guide the processing of the large language model (LLM) 128, and an output analyzer 122 for interpreting the results provided by the LLM. The AI/ML service 118 further connects to an external LLM integration service 126, enabling access to advanced natural language processing capabilities of the LLM 128.

FIG. 1 also depicts the inclusion of a project data model builder 124 that integrates with the AI/ML service 118 of the online video service 102. The project data model builder 124 receives the output from the LLM 128, as interpreted and processed by the output analyzer 122, which identifies relevant snippets satisfying the user's content selection criteria and specified project parameters. Utilizing this data, the builder 124 constructs the video project data model, organizing the identified snippets into a structured format that defines their sequence and timing within the video editing project. This data model acts as a blueprint, detailing the sequence, timing, and specific attributes of each video snippet selected for inclusion in the video editing project. The data model enables the dynamic assembly and real-time editing of the video project within the web-based interface, ensuring that the final output aligns with the user's creative vision and specified project parameters.

Together, the components illustrated in FIG. 1 form a framework that supports the analysis and manipulation of video content within the online video service 102. However, those skilled in the art will recognize that the architecture can be varied to accommodate different operational and/or technological needs. For instance, the video pre-processor 112, as a service, could be distributed across multiple server computers, and/or hosted via a cloud-based service, to enhance processing capabilities and reduce latency, especially when handling large volumes of video data. Additionally, the trained computer vision models 114 and speech-to-text models 116 may be combined with or replaced by other advanced machine learning models, offering additional features such as emotion detection, facial recognition, and so forth.

Moreover, the AI/ML service 118 may be designed to interface with one or more internally hosted LLMs, or with multiple external LLM integration services 126, not just a single service as shown in FIG. 1. By integrating with multiple LLM integration services 126, the AI/ML service 118 may leverage a variety of generative language models specialized for different tasks. In some instances, this provides a more robust and versatile platform capable of catering to a wider range of video editing projects. The prompt generator 120 and output analyzer 122 can also be equipped with machine learning capabilities to learn from user interactions and improve prompt generation and result interpretation over time.

Consistent with some embodiments, the video library 108 may incorporate cloud-based storage solutions to facilitate scalability and remote access, allowing users to upload and manage video content from various locations. The metadata associated with video clips or files 110 can be enriched with additional information, such as contextual data or user engagement metrics, to provide an even more comprehensive understanding of the content. Furthermore, in some examples, the web server 104 can be configured to support a microservices architecture, where each component of the application logic 106 operates as an independent service. This enables a more efficient update process, easier maintenance, and the ability to scale specific functionalities independently based on demand. These variations and others like them fall within the scope of the present invention, as the underlying principles of the video analysis and editing are maintained, albeit through different technological implementations.

Consistent with some embodiments, the system architecture of the online video service is designed to function within a Software as a Service (SaaS) framework, which incorporates a multi-tenancy architecture to efficiently serve multiple clients or customers-shown in FIG. 1 as enterprise-customer 130. Under this model, an enterprise-customer 130 enters into a contractual relationship with the online video service provider, allowing for the creation of individual user accounts for employees or designated groups within the enterprise, as an example. These accounts are interconnected and grouped under an enterprise account, ensuring a cohesive and organized structure for content management and collaboration.

Consistent with some embodiments, access to the online video service is facilitated through a web interface or via a dedicated application including in some instances a mobile application, thereby providing users 134 with the flexibility to interact with the service across various devices. The online video service 102 is designed to streamline the video management process, featuring automated mechanisms for uploading video content directly to the video library 108. The online video service 102 employs a role-based access control system, ensuring that user permissions are aligned with their specific functions and responsibilities within the enterprise. This control over access rights allows for a tailored user experience, where some users 134 may be limited to uploading and viewing their own video content, while others (e.g., admin users or editors 132) possess administrative and/or editing privileges. Users with elevated access can manage the entire video repository associated with the enterprise account, including the ability to edit, curate, and distribute video content as required. This role-based approach not only secures the content against unauthorized access but also streamlines workflows by assigning appropriate levels of control to users based on their role within the enterprise.

The overall system depicted in FIG. 1 operates as an online service or platform for video editing and project creation, leveraging the power of AI and machine learning to streamline the video production process. Users 134, which may include employees of an enterprise or individual contributors, continuously add video clips to the video library 108. These video clips may be created on an ad-hoc basis, or in response to a specific call-to-action, facilitated by the online video service. For example, an administrative user of the online video service 102 may generate via a user interface of the service a message, where the message is distributed to one or more users, for example, by email or via notification through a dedicated mobile application. The message may prompt each user to generate or record a video having a specific message, theme or specified set of characteristics-such as a testimonial, or similar. As new video clips are introduced to the system, the video pre-processor 112 engages to analyze each video clip, employing trained computer vision models 114 to visually parse the content and trained speech-to-text models 116 to transcribe any spoken words. This analysis results in the generation of rich text-based metadata for each video clip, capturing both visual and auditory elements that are needed for subsequent content curation. In this instance, the text-based metadata is well suited for processing by a generative language model.

Administrative users or those with editing privileges interact with the system via a web browser application and through the web server 104, utilizing the application logic 106 to define content selection criteria and other project parameters for a new video editing project. These selection criteria and project parameters serve as the foundation for the prompt generator 120 to create a tailored prompt, which encapsulates an instruction derived from the selection criteria and project parameters, and context that includes the metadata of video clips matching the specified attributes and characteristics as set forth by the selection criteria.

In accordance with various embodiments, the content selection criteria specified by the user or suggested by the system shape the narrative and thematic direction of the video editing project. Users may establish these selection criteria through a multifaceted interface that allows for granular control over the selection process. For instance, in some examples, users can specify criteria based on predefined tags associated with the video clips, enabling the selection of content that aligns with specific themes or subjects such as “corporate events” or “product launches.” The system may also suggest tags based on popular trends or previous selections made by the user, thereby streamlining the curation process.

Further, consistent with some examples, users can organize and select video clips using a folder hierarchy system, which categorizes content into structured groups for easy retrieval. This method is particularly useful for large enterprises with extensive video libraries, where content can be segmented by department, project, or campaign. Additionally, users can select video clips based on the source, such as a particular camera, camera type, or contributor, ensuring consistency in video quality and/or style. Date and time filters allow users to focus on content captured during specific events or periods, which can be used for creating time-sensitive or chronological narratives and thematic video projects.

Consistent with some embodiments, the user interface may present a variety of technical filters that enable users to select video clips based on their technical characteristics. These filters cater to the professional needs of users who require specific technical standards for their video projects. For example, users can filter clips by frames per second (fps) to ensure a consistent frame rate throughout the video. Aspect ratio filters may be deployed for tailoring video clips to the intended output format, particularly for web-based content where consistent display across various devices and display sizes is important. These filters enable the selection of clips with aspect ratios optimized for both mobile and desktop platforms, ensuring the final video project is displayed seamlessly on the diverse screen sizes and orientations encountered in modern web environments. Resolution filters allow users to choose clips of a certain quality, such as standard definition (SD), high definition (HD), 4K, or even 8K, ensuring that the final video project meets the clarity and detail required for its intended audience and distribution channels. These technical filters empower users to curate a collection of video clips that not only align with the thematic and narrative aspects of the project but also adhere to the precise technical specifications necessary for a polished and professional final product.

The user interface enhances the video editing experience by offering optional project parameters that shape the final video project data model, in addition to content selection. While users can specify the overall video length to target a specific duration for the project, the system can also automatically generate videos within the application's default target clip length range of 30 seconds to 1 minute and 30 seconds. The average snippet length parameter, which is optional, helps guide the selection of individual video segments to achieve the desired pacing and narrative flow. Users have the flexibility to set a limit on the number of snippets to prevent narrative congestion and to choose specific transitions to ensure visual consistency. When utilized, these parameters enable the project builder to intelligently select and sequence snippets. For example, should a user opt to define a project duration, such as five minutes with an average snippet length of ten seconds, the system will algorithmically curate snippets that satisfy both the content criteria and the optional temporal guidelines. The project builder utilizes pre-processed metadata, including time-coded speech transcripts, to confirm that the timing and arrangement of each snippet enhance the final video's coherence and viewer engagement, adhering to any project specifications provided by the user.

In some embodiments, the system's user interface includes a text input box where users can input a natural language query to articulate their content selection criteria. For example, users may enter phrases like “interviews with industry experts under bright lighting,” “high-energy sports action with cheering crowds,” or “employees describing their marketing tasks.” The system then crafts a refined LLM prompt instruction based at least in part on this natural language query. For example, the prompt generator of the system creates an LLM prompt based on this input. The instruction for the LLM prompt is derived to articulate the user's desired video snippets, incorporating both content selection criteria and project parameters. The context provided to the LLM is the metadata associated with video clips that meet the specified content selection criteria and project parameters, ensuring that the LLM's analysis is focused on the most relevant clips.

In some embodiment, the system employs a two-stage LLM prompting process. Initially, a first LLM prompt, which includes a static or system-defined instruction, is used to generate a recommended LLM prompt—specifically, the instruction component for selecting and/or ranking the snippets. This recommended prompt is then used to direct the LLM to analyze the video clips' metadata and identify snippets that align with the user's natural language query. This approach allows for a dynamic and iterative refinement of the content selection process, ensuring that the snippets chosen for the video editing project are closely aligned with the user's narrative intent and thematic preferences.

With some embodiments, once the initial set of video clips is selected, users can further refine the content based on additional selection criteria expressed in natural language. These criteria may encompass a range of narrative elements, from overarching themes to specific keywords or phrases that should be present in the dialogue. The system's prompt generator 120 utilizes these criteria to instruct the LLM 128 in identifying salient snippets within the selected video clips that best represent the desired narrative or thematic elements. For example, a user may request clips that showcase “sustainability practices” or contain interviews with “industry experts.” The LLM 128 processes these prompts against the metadata generated by the video pre-processor 112 to produce a curated set of video snippets that form the basis of the project data model.

The project data model, once established, is dynamically translated into an interactive web-based user interface, forming an integral part of the online video service 102. This sophisticated interface is crafted using a combination of modern web technologies, including HTML5 for structuring and presenting content, CSS3 for styling and layout, and JavaScript for creating interactive elements. These technologies work in concert to provide users 134 and editors 132 with a rich, responsive editing environment that is accessible through standard web browsers.

Consistent with some embodiments, HTML5 serves as the backbone of the user interface, defining the semantic structure of the web page where the video editing tools are housed. It enables the embedding of video content and the creation of a timeline view, which is central to the editing process. CSS3 is employed to style the interface, ensuring that the timeline and other editing tools are not only visually appealing but also intuitive to use. CSS3's advanced features, such as transitions and animations, enhance the user experience by providing smooth visual feedback as users interact with the timeline and make adjustments to the video project.

JavaScript, often in conjunction with frameworks like React or Angular, may be utilized to build the interactive aspects of the interface. It allows for the manipulation of the project data model in real-time, enabling users to perform actions such as dragging timeline elements, resizing clip durations, and previewing edits instantaneously. The use of AJAX (Asynchronous Javascript and XML) techniques may enable the interface to communicate with the server without requiring page reloads, making the editing process seamless and efficient.

The web-based interface also leverages APIs provided by the AI/ML service 118 to fetch alternative clip suggestions, apply user-defined edits, and update the project data model accordingly. This ensures that the interface remains synchronized with the underlying data model and reflects the latest changes made by the user.

By harnessing these web technologies, the online video service 102 offers a powerful and flexible editing platform that not only conforms to the user's specifications but is also augmented by the intelligent insights derived from the AI-driven components of the system. The result is a user-friendly, web-based video editing solution that streamlines the video project creation process while providing robust functionality and a high degree of customization.

Consistent with some embodiments, the present invention encompasses a recommendation engine that capitalizes on the capabilities of the LLM 128 to analyze a comprehensive collection or a curated selection of video clips from the video library 108. This analysis involves generating recommendations that suggest pertinent topics, themes, narratives, or other content-centric elements suitable for a video project. The recommendation engine operates by formulating system-defined prompts, which are then coupled with a rich collection of metadata associated with the specific collection or selection of video clips. This metadata, generated by the video pre-processor 112, includes but is not limited to text transcriptions from speech-to-text models 116, visual descriptors from computer vision models 114, and other relevant data points that encapsulate the essence of the video content.

Upon receiving the system-defined prompt and the corresponding metadata, the LLM 128 analyzes the metadata, leveraging its sophisticated natural language understanding to discern patterns, topics, and themes that are woven throughout the video clips. The analysis by the LLM seeks to uncover the underlying narrative threads that bind the clips together, thereby generating recommendations that resonate with the content's core message and the user's creative intent. For instance, if the video library 108 is replete with clips from corporate events and interviews with industry leaders, the LLM 128 may recommend themes such as “Innovation in the Workplace” or “Leadership Insights.” These recommendations are informed by the LLM's ability to recognize recurring motifs within the metadata, such as discussions on cutting-edge technologies or leadership philosophies.

In some embodiments, the system takes the recommendation process a step further by crafting LLM text-based prompts for each recommended theme or topic. These prompts are designed to guide the AI/ML service 118 in selecting and arranging the most salient snippets that align with the recommended theme or topic. For example, for the theme “Innovation in the Workplace,” the system might generate a prompt like “Select clips that demonstrate innovative solutions being implemented in office settings, including interviews with key personnel discussing the impact of these innovations.” The AI/ML service 118, utilizing the prompt generator 120 and output analyzer 122, then executes these prompts against the LLM 128, which in turn identifies and ranks video snippets that best illustrate the theme, creating a data model representation that serves as a blueprint for the video editing project.

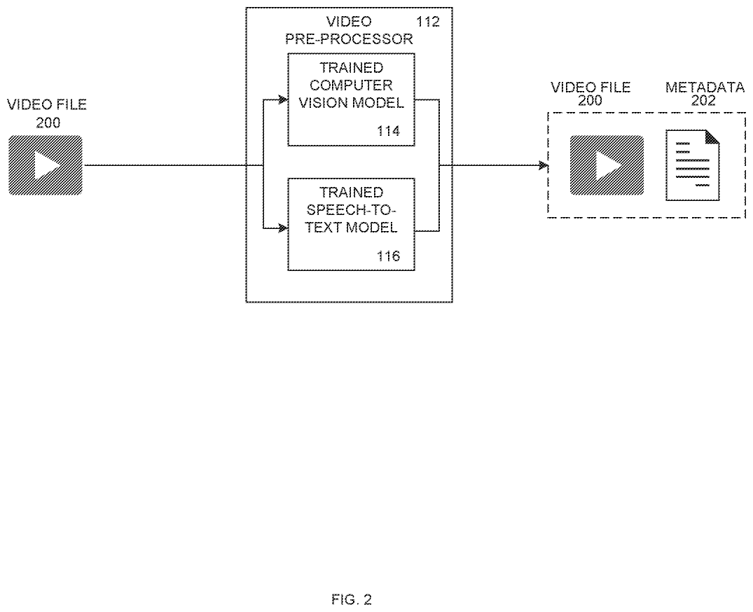

FIG. 2 is a diagram illustrating the functionality of the video pre-processor 112, according to some examples. The video pre-processor 112 analyzes video clips, referred to also as video files 200 in the initial stages of video clip analysis within the online video service. In various embodiments, the video pre-processor 112 may be equipped with a single model or an array of multiple models, each specialized in different types of analysis. Among these models, a trained computer vision model 114 is utilized to determine the visual content of video clips, identifying and cataloging objects, scenes, and activities within the frames. The output from this analysis is a textual description of the visual elements detected, providing a detailed account of the video's imagery. Concurrently, a trained speech-to-text model 116 processes the audio track of the video clip 200, converting spoken words into a written, text-based transcript. Both the visual and auditory analyses are enhanced with timing data, which marks the temporal occurrence of each identified object or spoken word within the video timeline. This timing data is essential as it enables precise synchronization of the metadata with the corresponding segments of the video, thereby laying the groundwork for accurate selection of relevant clips for inclusion in video editing projects and the construction of a coherent project data model.

The video pre-processor 112 receives a video file 200 as input. This video file 200 contains both visual and audio data that encapsulate the content of the video clip. The visual data includes the sequence of images that make up the video, while the audio data comprises the accompanying sound, which may include conversation, dialogue, music, ambient sounds, and other auditory elements. Upon receiving the video file 200, the video pre-processor 112 engages the trained computer vision model 114 to analyze the visual content. The computer vision model 114 is an advanced machine learning model that has been trained on a vast dataset of images and videos to recognize and interpret various objects and activities within the visual frames. As the model processes the video, it identifies and classifies objects, characters, and scenes, generating textual descriptions of each identified element. These descriptions are then timestamped to create a temporal map that links each visual element to its specific occurrence within the video timeline.

Simultaneously, the video pre-processor 112 utilizes the trained speech-to-text model 116 to process the audio track of the video file 200. This model is designed to convert spoken words into written text with high accuracy. It is capable of handling diverse accents, dialects, and varying speech qualities, ensuring that the dialogue and other vocal sounds are transcribed effectively. The speech-to-text model 116 also timestamps the transcribed text, providing timing data that indicates when each spoken word or phrase occurs within the video.

The output of the video pre-processor is a rich collection of metadata 202 that encapsulates both the visual and auditory content of the video clip. This metadata 202 includes the textual descriptions of visual elements from the computer vision model 114 and the transcribed dialogue from the speech-to-text model 116, along with their respective timing data. The metadata 202 can be embedded directly into the video file 200, creating an enriched media asset that carries its descriptive data within. Alternatively, the metadata 202 can be stored in a separate file, such as an XML or JSON document, which is then associated with the video file 200. This association ensures that the metadata 202 is readily accessible and can be referenced during the video editing process.

The text-based metadata 202 generated by the video pre-processor 112 is important for the AI-enhanced video editing system, as it enables the system to understand the content of the video clips at a granular level, facilitating the selection of salient snippets based on user-defined criteria in subsequent stages of the video editing workflow. The timestamped nature of the metadata 202 allows for precise editing decisions, ensuring that the resulting video project is a curated representation of the original content, tailored to the user's specifications and creative intent.

In some embodiments, the video pre-processor 112 may deploy additional machine learning (ML) models (not shown) to generate a broader spectrum of metadata. For instance, specialized models may be deployed to identify specific individuals through facial recognition technology, discern emotions from facial expressions and vocal tones, or detect keywords that signify particular themes or concepts within the video content. These models may operate in conjunction with the computer vision model 114 and the speech-to-text model 116 to provide a multi-dimensional analysis of the video clips, enriching the metadata 202 with layers of interpretive data that enhance the system's ability to select and organize video snippets with high relevance and precision.

Beyond the capabilities of ML models, the metadata 202 may also encompass additional information contributed by users or derived from the video's interaction history. Users may manually tag video content with descriptive labels, which are then incorporated into the metadata 202, providing another level of categorization and searchability. Furthermore, when video content is published on a company website or social media platform, any accompanying text, such as titles, descriptions, or hashtags, may become part of the metadata 202. Comments and feedback from viewers, which can offer insights into the video's reception and impact, are also captured within the metadata 202. This amalgamation of automated ML-generated data and user-generated content creates a comprehensive metadata profile for each video clip, significantly augmenting the AI-enhanced video editing system's ability to deliver tailored and contextually rich video projects.

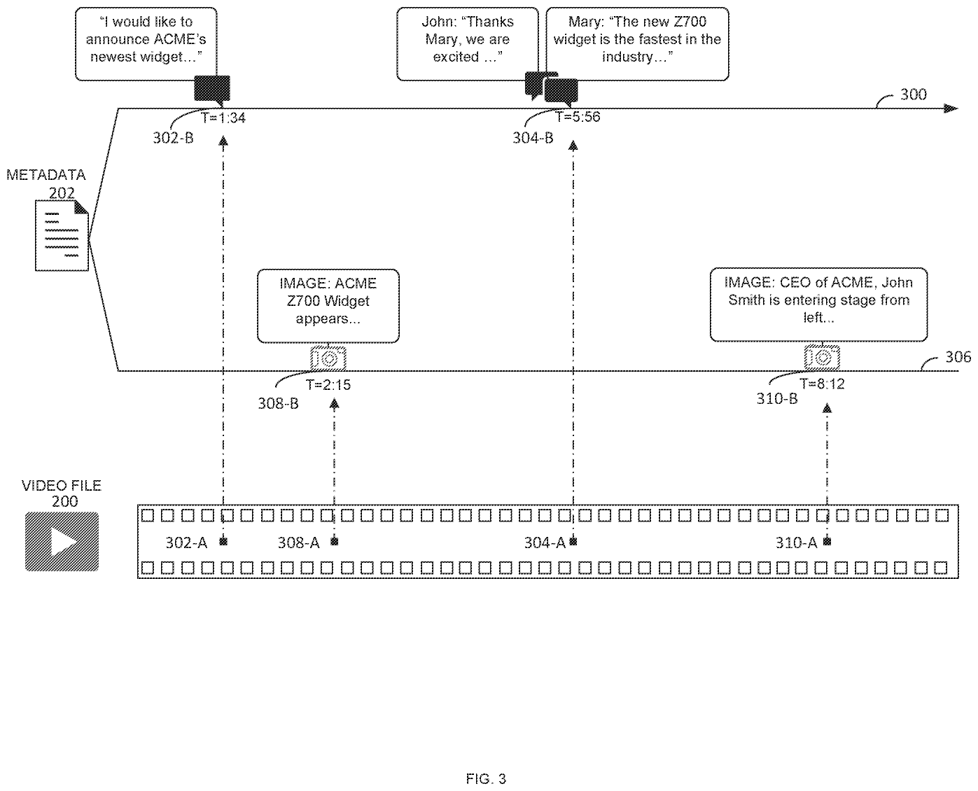

FIG. 3 is a diagram illustrating the relationship between a video clip or video file 200, and the metadata 202 that is generated for the video file 200 by the video pre-processor 112, according to some examples. The diagram serves as a visual representation of the dual analysis performed by the video pre-processor 112 on a single video clip or file 200. This dual analysis enriches the video clip 200 with metadata 202 that is subsequently used for content curation and editing processes.

The first timeline 300 in FIG. 3 demonstrates the output of the trained speech-to-text model 116. Here, the model has transcribed spoken words into text, which is then time-coded to align with the video's timeline. For example, at timecode T=1:34, with reference number 302-B, the text “I would like to announce ACME's newest widget . . . ” appears, indicating that this dialogue was spoken at that particular moment in the video clip. The reference number 302-A indicates the timing of this event with respect to the video file 200. Similarly, at timecode T=5:56, with reference number 304-B, another piece of dialogue is transcribed as “Mary: “The new Z700 widget is the fastest in the industry . . . ” Here again, the reference number 304-A indicates the timing of this event with respect to the video file 200. This precise timing data is crucial as it allows for the accurate synchronization of text with the spoken words, enabling easy location and selection of specific dialogue within the video clip.

The second timeline 306 in FIG. 3 showcases the results of the object detection performed by the trained computer vision model 114. This model analyzes the visual content of the video clip 200 and identifies significant objects or events. For instance, at timecode T=2:15, with reference number 308-B, the model has detected the appearance of an object with the text “IMAGE: ACME Z700 Widget appears . . . ” This indicates that the product in question is visually present in the video at that time. Another example is at timecode T=8:12, with reference 310-B, where the model identifies “IMAGE: CEO of ACME, John Smith is entering stage from left . . . ” These visual annotations provide context and understanding of the video's content beyond the audio layer, offering a comprehensive view of the events occurring within the clip.

Together, these two timelines form a synchronized metadata framework that captures both the auditory and visual elements of the video clip. This text-based metadata 202 allows for the automated curation of the content by the AI-driven system, as it provides a searchable, indexed database of the video clip's content. For instance, if an editor is tasked with creating a highlight reel featuring key product announcements and executive appearances, they can quickly locate these moments using the metadata. The speech-to-text timeline 300 allows them to find instances where the product is discussed, while the computer vision timeline 306 helps them identify when the product and key individuals are visible on screen,

In practice, this metadata-enriched framework enables a multitude of video editing applications. It allows for the automated generation of subtitles and captions, the creation of thematic summaries based on dialogue, and the compilation of visually-driven stories where specific objects or people are the focal points. The metadata 202 thus serves as the foundation for a data-driven approach to video editing, where content can be efficiently organized, retrieved, and repurposed to meet the diverse needs of video production workflows.

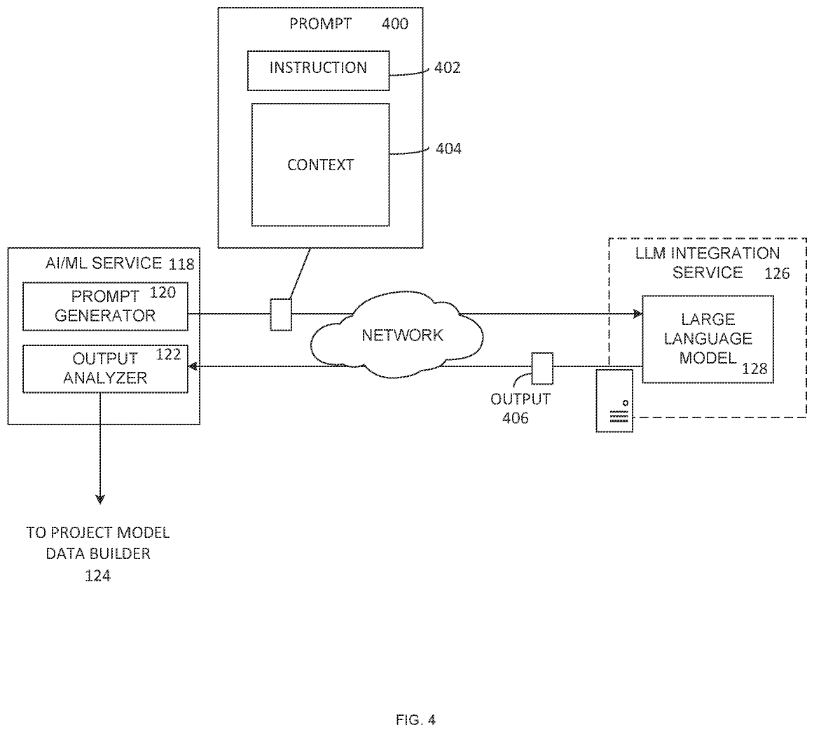

FIG. 4. is a diagram illustrating the interaction between an AI/ML service 118 that is a component of the online video service 102, with an external large language model (LLM) integration service 126, consistent with some examples. The AI/ML service 118, through its prompt generator 120, formulates prompts that guide the LLM 128 in processing text-based metadata associated with video content. The prompt generator 120 utilizes content selection criteria as provided or specified by a user, which may be inputted by the user through any of a variety of user interface mechanisms, including but not limited to: text input fields, dropdown menus, checkboxes and radio buttons, sliders, search bars, tag selection tools, a voice command interface, interactive visualizations, gesture-based controls, collaborative filtering widgets, and so forth. In this example, the AI/ML service 118 communicates with the external large language model (LLM) integration service 126 over the network through the use of application programming interfaces (APIs) or similar protocols, which facilitate the secure and efficient exchange of data and instructions necessary for the processing of text-based metadata associated with the video content.

In some embodiments, the prompt generator 120 leverages the content selection criteria to create an instruction 400 that is tailored for use with the LLM prompt 400. This involves analyzing the user-provided criteria and distilling them into a directive that the LLM 128 can act upon. For instance, the prompt generator 120 may interpret criteria such as “highlighting innovation in renewable energy” to formulate an instruction like “Extract segments where renewable energy innovations are discussed or demonstrated.” The system's intelligence is applied to ensure that the instruction is specific enough to guide the LLM 128 effectively while remaining flexible to the nuances of natural language.

Consistent with some embodiments, the prompt generator 120 employs the user-specified content selection criteria to craft the instruction 402 portion of the prompt 400. This process may be template-based, where a predefined template is populated with specific inputs mapped to and derived from the content selection criteria. For instance, if the user specifies a theme of “environmental conservation efforts,” the prompt generator 120 might fill in a template with this theme to create an instruction such as “Identify clips that showcase environmental conservation efforts.”

Alternatively, the prompt generator 120 may use more sophisticated methods to generate the instruction 402, such as natural language processing techniques that interpret the user's input and translate it into a coherent and contextually relevant prompt 400. For example, the user might input a series of keywords or phrases, and the prompt generator 120 would construct a natural language instruction 402 that encapsulates the essence of these inputs.

Furthermore, the system may utilize predefined LLM prompts as a starting point to generate an appropriate instruction 402 for a subsequent, more refined prompt. In this iterative process, the LLM 128 can be engaged to suggest potential instructions based on a broad initial prompt derived from the user's selection criteria. The output from the LLM 128, which includes recommended or suggested instructions, is then evaluated by the prompt generator 120. The most relevant suggestions are either presented to the user for confirmation or automatically incorporated into a new, optimized prompt. This dynamic interaction between the prompt generator 120 and the LLM 128 allows for the creation of highly effective prompts that are increasingly aligned with the user's intent and the content's context, thereby enhancing the precision of the video content selection process.

In addition to generating the instruction 402 for the prompt 400, the prompt generator 120 selects and aggregates metadata for the video clips that meet the user-provided content selection criteria. This metadata, which serves as the context 404 in the prompt, is included in the prompt to provide the LLM 128 with the necessary information to analyze the video content accurately. The context 404 may include text transcriptions, object identifications, timestamps, and other relevant data points that describe the content of the video clips.

The use of one-shot or few-shot learning techniques can be relevant in this process, especially when the LLM 128 needs to understand and execute tasks based on limited examples or instructions. In such cases, the prompt generator 120 may include examples (not shown) within the prompt 400 to illustrate the desired output, effectively ‘teaching’ the LLM 128 how to perform the analysis with just a few iterations. Consistent with some embodiments, function calling is another approach that the prompt generator 120 might employ. Here, the prompt 400 may include a call to a specific function or module within the LLM 128 that is designed to perform a particular type of analysis, such as sentiment analysis or topic clustering. This method allows for a more modular and targeted analysis of the video content.

Once the prompt 400 is generated, it is communicated over the network, typically via an API call or request, to the LLM integration service 126. The LLM 128 processes the prompt and returns the output 406 to the output analyzer 122. The output analyzer 122 then examines the LLM's output 406, extracting valuable insights and data that are used by the data model builder 124 to construct the video project data model. This model ultimately serves as the blueprint for the video editing project, guiding the selection and arrangement of video clips to create a final product that aligns with the user's vision and the content's thematic elements.

In certain embodiments, the application logic 106 within the online video service 102 may orchestrate the flow of prompt generation and submission to the LLM integration service 126. This centralized control mechanism ensures that prompts are generated in a sequence that aligns with the user's editing objectives and the system's operational logic. In complex video editing projects, multiple prompts may be submitted sequentially or in parallel, each designed to fulfill a specific function within the content selection and organization process.

Some prompts may be crafted specifically to identify and select snippets from the video content that match the user's thematic or topical criteria. These prompts direct the LLM 128 to focus on finding segments of the video that are contextually relevant to the specified themes or subjects. Once a collection of potential snippets is identified, additional prompts may be employed to further refine the selection. For instance, subsequent prompts may instruct the LLM 128 to rank or order the snippets based on various factors such as relevance to the central theme, narrative flow, or viewer engagement metrics.

Moreover, diversity in snippet selection can be an important consideration, particularly in projects aiming to showcase a wide range of perspectives or to cover multiple facets of a topic. In such cases, prompts may be designed to encourage the LLM 128 to identify a diverse array of snippets that, when combined, provide a comprehensive and multifaceted view of the subject matter. The application logic 106 manages the submission of these prompts, ensuring that the LLM 128's analysis yields a balanced and varied selection of video content that meets the project's diversity criteria, if and when desired and specified, and enhances the storytelling quality of the final video project.

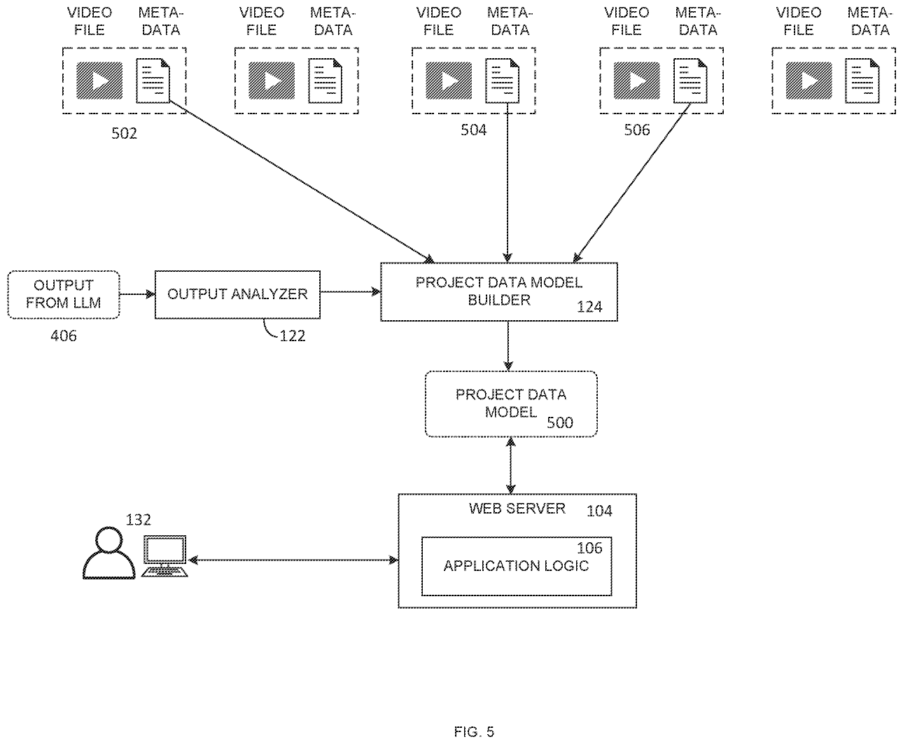

FIG. 5 is a diagram illustrating how a project data model builder 124 processes the output 406 from an LLM to generate a video project data model 500 for a video editing project, according to some examples. The process begins with the output analyzer 122, which receives the output data 406 from the LLM. This data includes information identifying specific video clips, and detailed timing information about relevant snippets within the video clips that have been identified as pertinent to the user's specified content selection criteria.

Consistent with some embodiments, the output analyzer 122 may operate as a rule-based system, where it applies a set of predefined rules and conditions to the data received from the LLM's output 406. These rules are designed to extract the pertinent information while ensuring that the data satisfies specific criteria relevant to the video editing project's objectives. For example, the rules may pertain to the length of snippets, the presence of certain keywords, the frequency of a particular subject matter, or the inclusion of specific visual elements that are crucial to the project's theme.

As the output analyzer 122 processes the LLM's output 406, it actively filters and categorizes the snippets based on these rules. It may prioritize snippets that strongly align with the user's thematic requirements or discard those that do not meet the set quality thresholds or relevance scores. The rule-based approach allows for a systematic and consistent evaluation of the LLM's output, ensuring that the final selection of snippets is not only contextually appropriate but also adheres to the project's technical and stylistic standards.

Additionally, the output analyzer 122 may employ a verification process to confirm the accuracy and appropriateness of the data extracted. This process might involve cross-referencing the snippets against other metadata or user inputs to validate their accuracy and relevance. By implementing such rule-based analysis and verification, the output analyzer 122 acts as a gatekeeper, refining the raw output from the LLM into a curated set of data that is ready for the project data model builder 124 to use in constructing the video project data model 500.

Upon analyzing the LLM's output, the output analyzer 122 communicates the relevant data and instructions to the project data model builder 124. The project data model builder 124 is responsible for constructing the project data model 500, which serves as the blueprint for the video editing project. It incorporates data specifying the timing details of the relevant snippets from the selected clips, such as clips 502, 504, and 506. These details include the start and end points of each snippet within the original video files, as well as any transitional elements or additional metadata that may be necessary for the editing process.

The project data model builder 124 may utilize a default rate of speaking to refine the lengths of individual snippets, ensuring they conform to project parameters concerning snippet duration or the overall length of the video clip. By applying this default speech rate, the builder 124 can estimate the spoken content's duration within each snippet and adjust the start and end points accordingly. For instance, if the project requires a 30-second clip but the initial selection of snippets exceeds this duration, the project data model builder 124 can shorten the snippets by trimming content from the beginning or end of the speech segments, or by selecting shorter snippets that still convey the necessary information. Conversely, if the total duration falls short of the desired length, the project data model builder 124 can extend snippets or include additional content, all while maintaining the integrity of the narrative flow and ensuring that each snippet remains contextually coherent and relevant to the video project's theme.

The project data model builder 124 is also tasked with processing a range of user or system-defined project parameters that dictate the inclusion and configuration of various additional assets within the video project. These parameters may specify the types of video transitions—such as cuts, fades, or wipes—that should be used between clips, as well as the style, timing, and placement of graphic and text overlays, including logos, captions, subtitles, and other textual elements. The builder 124 interprets these parameters to determine not only which additional assets are to be incorporated into the project data model but also how they are to be integrated. For example, it may place a logo overlay at the corner of the video throughout its duration or insert subtitles synchronized with the speech in each snippet. By adhering to these parameters, the builder 124 ensures that the additional assets are seamlessly woven into the project data model 500, enhancing the visual and informational quality of the final video while adhering to the user's creative vision and branding requirements.

The resulting project data model 500 is a comprehensive representation of the video project, encapsulating the sequence and arrangement of video snippets that will form the final video, when rendered. It is designed to be dynamic and interactive, allowing for further refinements and adjustments by the user. Once the project data model 500 is generated, it is transformed into a visual representation that can be rendered within a web browser. This visual representation is served to the web browser in use by a user, such as an editor 132, who can interact with the model through a web-based video editing interface.

The web-based interface provides a user-friendly environment for editors to visualize and manipulate the video project. It offers a timeline view where the snippets are displayed in sequence, along with editing tools that enable users to make precise adjustments to the project data model. Editors can trim or extend snippets, modify transition effects, and rearrange the sequence of content to achieve the desired outcome. The interface reflects changes in real-time, providing immediate visual feedback as the project data model is edited.

As illustrate in FIG. 5, the innovative system bridges the gap between AI-generated content analysis and the creative control afforded by traditional video editing. It illustrates a seamless transition from AI-driven content recommendations to the creation of an editable project data model, ultimately empowering users to produce video projects that are both data-informed and creatively inspired.

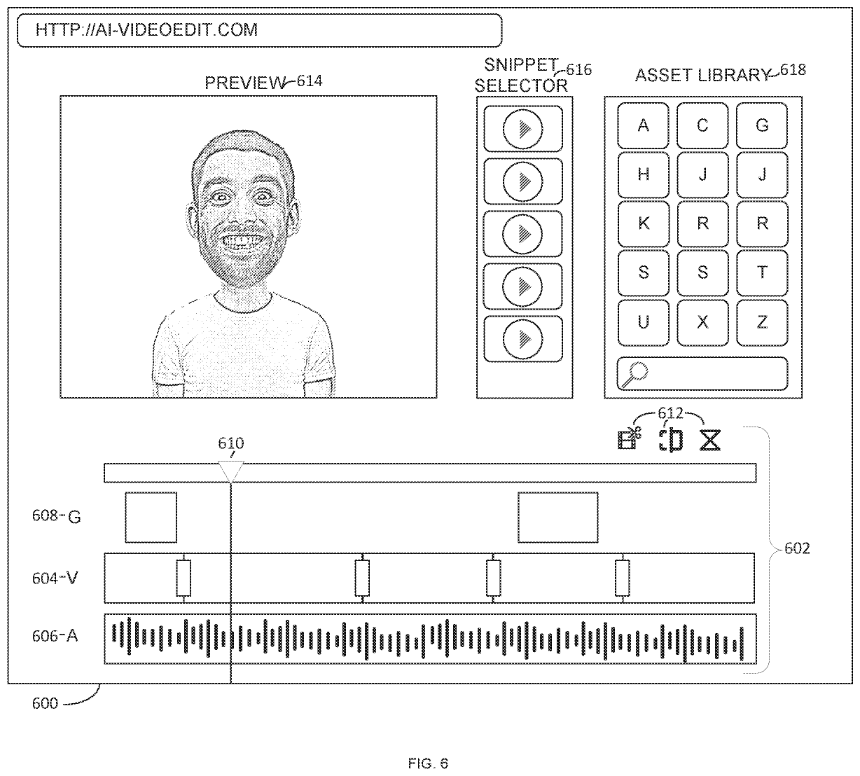

FIG. 6 is a user interface diagram 600 illustrating an example of a web-based video editing application for an online video service, displaying a web-based visual presentation of the video project data model as generated by the video online service, consistent with some examples. As illustrated in FIG. 6, the user interface is organized into distinct UI elements and modules, each serving a specific function in the video editing workflow.

The central feature of the interface is the timeline module 602, which displays a linear representation of the video project. This timeline includes conventional elements such as tracks for video 604, audio 606, graphics and text 608, and a playhead 610 for scrubbing through content, and tools for cutting, trimming, and arranging video snippets 612. Above the timeline, a monitor or preview window 614 shows the current frame or plays back the sequence, allowing users to review their work in real-time.

Above the timeline 602, a specialized UI element, referred to as the “Snippet Selector,” 616 presents a visual representation of additional video clips recommended via the processing steps performed by the LLM but not initially selected for the project. Each clip is represented by a thumbnail image, and hovering over or clicking on a thumbnail allows the user to preview the specific snippet. This preview functionality is advantageous for editors, as it allows editors to evaluate how well these alternative snippets might fit within the context of the existing project. If an editor decides to replace a snippet in the timeline 602, they can simply drag and drop the new snippet from the “Snippet Selector” 616 into the desired location on the timeline, where it automatically snaps into place and updates the project data model.

In another UI module, the “Asset Library” 618, a curated list of editing assets is displayed. These assets, which include transitions, graphics, text overlays, and other complementary elements, have been pre-selected using the aforementioned processing by the LLM based on their relevance to the video project. The project data model builder 124 generates a prompt incorporating metadata from the video project, which is then provided to the LLM. The LLM processes this prompt and outputs a selection or ranking of assets that harmonize with the narrative or thematic elements of the video snippets included in the project.

The “Asset Library” 618 is designed for quick access and ease of use, with assets organized into categories and searchable by keywords or tags. Users can drag and drop these assets onto the timeline, integrating them into the video project with precision. The interface also provides contextual suggestions, highlighting assets that are particularly well-suited to the currently selected snippet or portion of the timeline.

Overall, the user interface of this web-based video editor is crafted to enhance the efficiency and creativity of the editing process. By leveraging the power of AI through the LLM, the system not only simplifies the initial selection of video content but also streamlines the incorporation of additional assets, ensuring that editors can produce high-quality video projects that resonate with their intended audience.

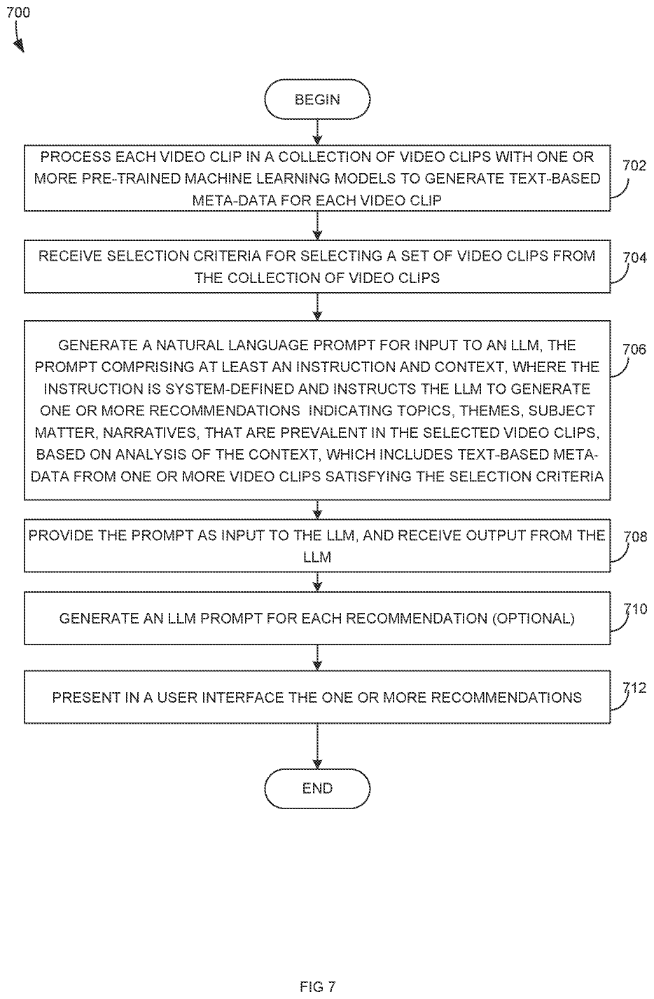

FIG. 7 presents a flow diagram that outlines the computer-implemented method 700 for generating a recommendation to be presented to a user. This recommendation specifies a topic, theme, subject matter, or narrative that serves as a focal point for analyzing a selection of video clips. The purpose of generating such a recommendation is to address a common problem faced by users: a lack of in-depth knowledge of the content within their video libraries. Users may possess extensive collections of video clips but lack the time or expertise to thoroughly review and understand the content of each clip. To mitigate this issue, the system is equipped to analyze the content, particularly the text-based metadata extracted from the video clips, using an LLM. By doing so, the system can intelligently make recommendations about specific themes or topics around which a video project, such as a highlight reel or thematic video, could be generated. This automated analysis and recommendation process empowers users to create meaningful and focused video content without requiring them to manually sift through and interpret their entire video collection.

The first operation 702 in the method involves pre-processing a collection of video clips. During this phase, each video clip in a collecting of video clips is analyzed by a speech-to-text algorithm to extract text-based metadata, which includes a transcription of the spoken words within the video clips. The video clips may also be processed with a variety of other models to identify objects, emotions, facial expressions, and so forth-all of which result in text-based metadata for the video clip. This text is time-coded, providing precise alignment with the corresponding speech and events in the video clips. This metadata allows for the content within the video clips to be searchable and indexable.

Following the pre-processing, the method optionally includes an operation 704 where the user interface of a web-based application receives selection criteria from the user. For example, the user interface allows a user to input or select various content selection criteria or other parameters that define a search for relevant video clips within the larger collection. In this way, a user can request a recommendation for a topic or theme around which a video project may be generated, for a specific group or set of video clips. Alternatively, the user may simply select a user interface element (e.g., a button) to request analysis of the entire video library.

In method operation 706, as illustrated in FIG. 6, the system is configured to generate a natural language prompt for input to a Large Language Model (LLM). This prompt comprises a system-defined instruction paired with a dynamically generated context derived from metadata extracted from user-selected video clips. With some embodiments, the instruction directs the LLM to analyze the provided context—that is, the metadata for the collection or selection of video clips—and to generate recommendations on topics, themes, subject matter, or narratives prevalent within the video clips. The context is created by aggregating text-based metadata, including time-coded transcriptions from the video clips' audio tracks, and may incorporate additional metadata such as speaker identification and sentiment analysis. The system then constructs a comprehensive prompt that combines the instruction with the rich context, enabling the LLM to understand and process the content of the video clips effectively. For instance, the prompt may instruct the LLM to “Identify the main topics and themes from the provided text data,” ensuring that the LLM's analysis is focused and relevant to the user's project goals.

At method operation 708, as depicted in the figure, the system executes an interaction with the Large Language Model (LLM) by providing the constructed natural language prompt as input. This prompt, which encapsulates both the system-defined instruction and the metadata associated with the selected video clips, is processed by the LLM to perform a targeted content analysis. Upon receipt of the prompt, the LLM applies its advanced natural language understanding capabilities to dissect the provided information and generate output that aligns with the user's specified content criteria. The system then receives this output from the LLM, which includes a set of recommendations or insights regarding the topics, themes, subject matter, or narratives identified within the video clips. This output forms the basis for subsequent steps in the video editing project, as it guides the selection and arrangement of video snippets to construct a coherent and contextually relevant narrative for the final video product.

In certain embodiments, the system enhances the recommendation process by formulating specific LLM prompts tailored to each recommended theme or topic, as indicated in method operation 710. These prompts are constructed to direct the LLM in pinpointing and compiling the most pertinent snippets that resonate with the identified theme or topic. For instance, if the theme “Innovation in the Workplace” is recommended, the corresponding LLM prompt might be “Identify clips showcasing innovative practices in office environments, spotlighting interviews with pivotal staff discussing the effects of these innovations.” The AI/ML service 118, through the collaborative efforts of the prompt generator 120 and the output analyzer 122, activates these prompts within the LLM 128. The LLM then discerns and prioritizes video snippets that most accurately reflect the theme, thereby crafting a data model representation that lays the groundwork for the ensuing video editing project.

Each LLM prompt is designed to fulfill a particular recommendation. For example, should a recommendation indicate that a video project could be centered around a specific theme, the LLM prompt crafted for that recommendation will endeavor to identify and select the most relevant video clips and snippets associated with that theme. An LLM prompt may be created for each recommendation displayed to the user. Alternatively, the system may generate an LLM prompt for a particular recommendation only after the user has selected or shown interest in that specific recommendation. This approach ensures that the system's resources are efficiently utilized and that the user's input directly influences the content curation process, leading to a more personalized and targeted video project outcome.

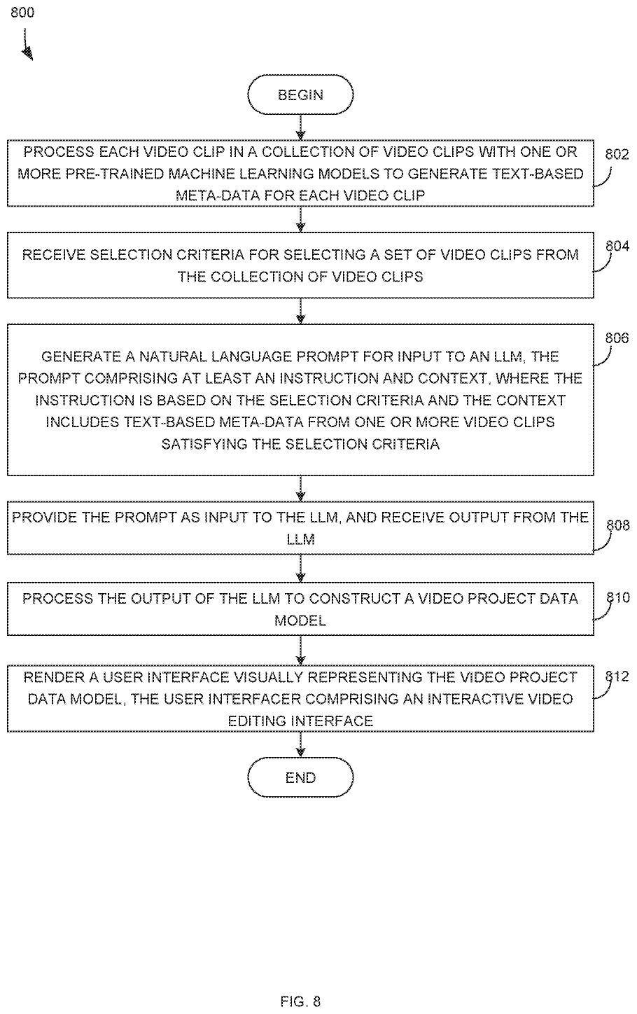

FIG. 8 is a flow diagram illustrating the method operations of a computer-implemented method 800 for generating a video editing project, consistent with some examples. The flow diagram outlines a series of method operations or steps that leverage machine learning models to transform a collection of video clips into a curated video editing project that aligns with user-defined criteria.

The first operation 802 involves processing each video clip in a collection of video clips with one or more pre-trained machine learning models to generate text-based metadata for each video clip. This operation lays the groundwork for the subsequent selection and editing processes. For example, a speech-to-text model may transcribe the audio content of the clips, while a computer vision model may identify and tag visual elements such as objects, scenes, and actions. The resulting text-based metadata is time-coded and associated with its respective video clip, providing a searchable index of the content. In some embodiments, additional metadata may be associated with a video clip,

Next, at operation 804, the system receives selection criteria for selecting a set of video clips from the collection. This step is user-driven and may involve inputting specific keywords, themes, or other descriptive parameters into the system. For instance, a user may input “sustainable energy” as a theme to filter the video clips that discuss or visually represent this topic. The system uses the provided criteria to filter and identify a subset of video clips that match the user's intent.

Following the selection of relevant clips, at operation 806, the system generates a natural language prompt for input to an LLM. The prompt comprises at least an instruction and context, where the instruction is based on the selection criteria and the context includes text-based metadata from one or more video clips satisfying the selection criteria. For example, the prompt might instruct the LLM to “Identify the most impactful statements about sustainable energy” and provide it with the transcribed dialogues from the selected clips as context.

At operation 808, the prompt is then provided as input to the LLM, and the system receives output from the LLM. The LLM analyzes the provided context in light of the instruction and generates output that highlights the most relevant snippets of video content. This output may include a ranked list of snippets with associated timecodes that best match the prompt's instruction.

Subsequently, at operation 810, the system processes the output of the LLM to construct a video project data model. This model organizes the identified snippets into a coherent structure that reflects the desired narrative or theme of the video project. For instance, the model may arrange snippets in a sequence that tells a compelling story about the advancements in sustainable energy.

Finally, at method operation 812, the system renders a user interface visually representing the video project data model. The user interface comprises an interactive video editing interface that allows users to further refine the video project. Users can interact with the timeline, adjust the length of clips, reorder segments, and preview the edited project in real-time. For example, an editor may use the interface to fine-tune the transitions between clips to ensure a smooth narrative flow.

FIG. 8 illustrates a method that marries sophisticated AI technology with user-centric design to improve the video editing process. This innovative approach offers significant advantages by automating the labor-intensive tasks of content analysis and selection, while also providing a dynamic and interactive editing interface. One advantage of the system is that the final output is a visual representation of a data model within a web interface. This allows users to refine and edit their video projects with precision and ease before rendering the final video output. Furthermore, the AI-driven recommendations for additional clips and assets enable users to seamlessly integrate new content that aligns with the project's goals and narrative. This not only enhances the relevance and quality of the final video but also streamlines the creative process, making it more efficient and user-friendly. The system's ability to suggest contextually appropriate content based on the project's themes ensures that users can craft a compelling story without the need for extensive manual searching and selection, thereby unlocking new possibilities in video project creation.

### Machine and Software Architecture

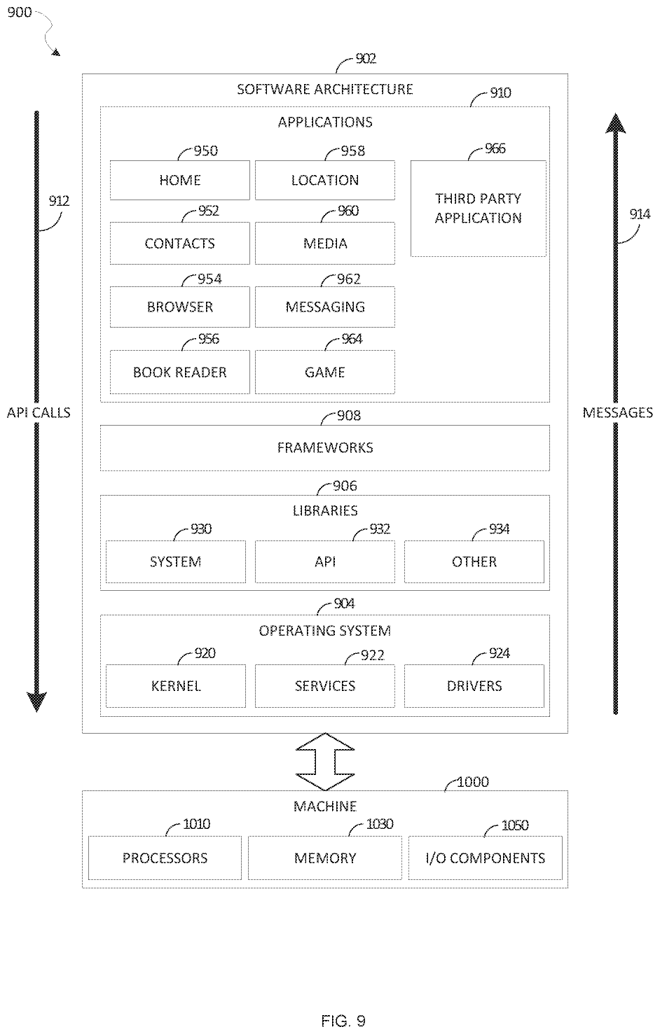

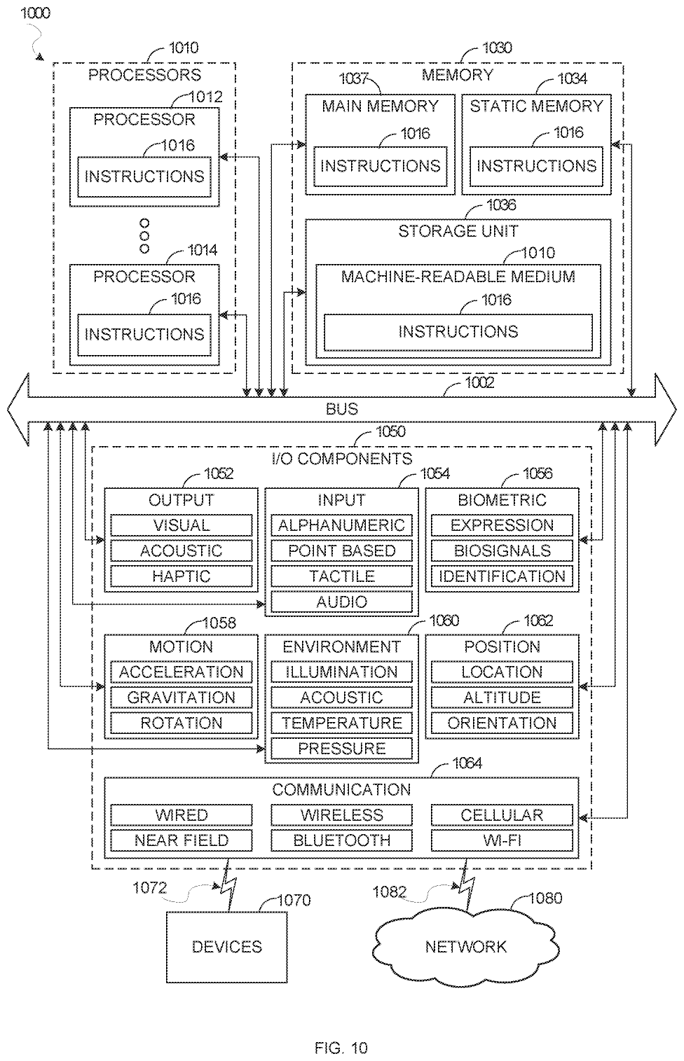

FIG. 9 is a block diagram 900 illustrating a software architecture 902, which can be installed on any of a variety of computing devices to perform methods consistent with those described herein. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example architecture, the software architecture 902 can be conceptualized as a stack of layers where each layer may provide a particular functionality. For example, the software architecture 802 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 912 provided by the operating system 904 to facilitate functionality described herein.

FIG. 10 illustrates a diagrammatic representation of a machine 1000 in the form of a computer system within which a set of instructions may be executed for causing the machine to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute any one of the methods or algorithmic techniques described herein. Additionally, or alternatively, the instructions 1016 may implement any one of the systems described herein. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 916 to perform any one or more of the methodologies discussed herein.

The machine 1000 may include processors 1010, memory 1030, and VO components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036, all accessible to the processors 1010 such as via the bus 1002. The main memory 1030, the static memory 1034, and storage unit 1036 store the instructions 1016 embodying any one or more of the methodologies or functions described herein. The instructions 916 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 10510, environmental components 1060, or position components 1062, among a wide array of other components. For example, the biometric components 1056 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1030, 1032, 1034, and/or memory of the processor(s) 1010) and/or storage unit 1036 may store one or more sets of instructions and data structures (e.g., software) embodying or utilized by any one or more of the methodologies or functions described herein. These instructions (e.g., the instructions 1016), when executed by processor(s) 1010, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

1. A computer-implemented method for generating a video editing project, the method comprising:
with selection criteria received via a user interface of a web-based application, selecting a set of video clips from a collection of pre-processed video clips, each pre-processed video clip being associated with metadata comprising text corresponding with speech, the text derived from applying a speech-to-text algorithm to an audio track of the video clip and associated with timing data indicating a temporal occurrence of the speech within the video clip;
generating a prompt for use as input to a generative language model, the prompt including i) a natural language instruction derived from the selection criteria received that directs the generative language model to identify timing data for salient snippets relevant to the selection criteria, and ii) a context portion that includes the metadata from the selected video clips;
providing the generated prompt as input to the generative language model, wherein the generative language model processes the prompt and generates output comprising data for constructing a project data model, the data including timing data for salient snippets within the selected video clips;
constructing a project data model from the output of the generative language model, wherein the project data model includes references to one or more of the selected video clips and specifies a beginning point and an ending point for the salient snippets based on the timing data identified by the generative language model; and
rendering a dynamic and interactive web-based user interface that visually represents the project data model, the user interface providing a timeline view of the video editing project and enabling user interaction for editing and refining the video project based on the project data model.

2. The computer-implemented method of claim 1, further comprising pre-processing the video clips to include text corresponding with objects depicted in the video clips, the text derived from applying one or more computer vision algorithms to the video clips, wherein the metadata associated with each pre-processed video clip includes this text, and wherein the generative language model utilizes the text to enhance the identification of salient snippets based on both the speech and depicted objects within the video clips.

3. The computer-implemented method of claim 1, wherein the natural language prompt characterizes content desirable to a user as specified in the selection criteria, the prompt comprising one or more of a topic, a theme, a subject matter, a sentiment, specific keywords or phrases, questions or answers, narrative elements, or actionable content;
wherein the generative language model identifies salient snippets from the selected video clips that correspond to the characterized content.

4. The computer-implemented method of claim 1, wherein the selection criteria received via the user interface further include one or more of the following: video clip tags, folder hierarchy, source-based selection, date and time filters, content analysis metrics, user engagement data, quality and resolution specifications, or custom queries, which collectively or individually contribute to the selection of the set of video clips from the collection.

5. The computer-implemented method of claim 1, wherein the selection criteria received via the user interface further include a desired length for a final video, and wherein a default rate of speech is applied to the text associated with the selected video clips to determine a duration of each snippet to be included in the video project, such that the cumulative length of all selected snippets approximates the desired video length.

6. The computer-implemented method of claim 1, wherein the selection criteria received via the user interface for selecting the set of video clips from the collection include at least one or more of the following, expressed in the alternative or in any combination:
video clip tags corresponding to topics or descriptive elements;
an indicator of one or more folders, wherein video clips are organized within a folder hierarchy;
selection based on a source of the video clips; and
filter selections based on date and time of video clip creation or modification, source, or other content analysis metrics that categorize the video clips according to predefined parameters.

7. The computer-implemented method of claim 1, wherein the project data model facilitates the presentation of user interface elements representing additional relevant video snippets that are not initially included in the video project, allowing the user to preview and select these snippets for addition to or replacement of existing snippets within the project, thereby providing an advantage of identifying and presenting potential content options within the user interface without formally incorporating them into the project data model until selected by the user.

8. The computer-implemented method of claim 1, wherein the user interface enables the user to specify additional editing parameters for the video editing project, including but not limited to desired video clip length, transition effects between clips, background music selection, overlay graphics, and text annotations, which are incorporated into the project data model to guide the rendering of the web-based user interface and a final video editing workflow.

9. A system for generating a video editing project, the system comprising:
one or more processors;
a memory storage device storing instructions thereon, which, when executed by the one or more processors cause the system to perform operations comprising:
with selection criteria received via a user interface of a web-based application, selecting a set of video clips from a collection of pre-processed video clips, each pre-processed video clip being associated with metadata comprising text corresponding with speech, the text derived from applying a speech-to-text algorithm to an audio track of the video clip and associated with timing data indicating a temporal occurrence of the speech within the video clip;
generating a prompt for use as input to a generative language model, the prompt including i) a natural language instruction derived from the selection criteria that directs the generative language model to identify timing data for salient snippets relevant to the selection criteria, and ii) a context portion that includes the metadata from the selected video clips;
providing the generated prompt as input to the generative language model, wherein the generative language model processes the prompt and generates output comprising data for constructing a project data model, the data including timing data for salient snippets within the selected video clips;
constructing a project data model from the output of the generative language model, wherein the project data model includes references to one or more of the selected video clips and specifies a beginning point and an ending point for the salient snippets based on the timing data identified by the generative language model; and
rendering a dynamic and interactive web-based user interface that visually represents the project data model, the user interface providing a timeline view of the video editing project and enabling user interaction for editing and refining the video project based on the project data model.

10. The system of claim 9, wherein the operations further comprise:
pre-processing the video clips to include text corresponding with objects depicted in the video clips, the text derived from applying one or more computer vision algorithms to the video clips, wherein the metadata associated with each pre-processed video clip includes this text, and the generative language model utilizes the text to enhance the identification of salient snippets based on both the speech and depicted objects within the video clips.

11. The system of claim 9, wherein the natural language prompt characterizes content desirable to a user as specified in the selection criteria, the prompt comprising one or more of a topic, a theme, a subject matter, a sentiment, specific keywords or phrases, questions or answers, narrative elements, or actionable content;
wherein the generative language model identifies salient snippets from the selected video clips that correspond to the characterized content.

12. The system of claim 9, wherein the selection criteria received via the user interface further include one or more of the following: video clip tags, folder hierarchy, source-based selection, date and time filters, content analysis metrics, user engagement data, quality and resolution specifications, or custom queries, which collectively or individually contribute to the selection of the set of video clips from the collection.

13. The system of claim 9, wherein the selection criteria received via the user interface further include a desired length for a final video, and wherein a default rate of speech is applied to the text associated with the selected video clips to determine a duration of each snippet to be included in the video project, such that the cumulative length of all selected snippets approximates the desired video length.

14. The system of claim 9, wherein the selection criteria received via the user interface for selecting the set of video clips from the collection include at least one or more of the following, expressed in the alternative or in any combination:
video clip tags corresponding to topics or descriptive elements;
an indicator of one or more folders, wherein video clips are organized within a folder hierarchy;
selection based on a source of the video clips; and
filter selections based on date and time of video clip creation or modification, source, or other content analysis metrics that categorize the video clips according to predefined parameters.

15. The system of claim 9, wherein the project data model facilitates the presentation of user interface elements representing additional relevant video snippets that are not initially included in the video project, allowing the user to preview and select these snippets for addition to or replacement of existing snippets within the project, thereby providing an advantage of identifying and presenting potential content options within the user interface without formally incorporating them into the project data model until selected by the user.

16. The system of claim 9, wherein the user interface enables the user to specify additional editing parameters for the video editing project, including but not limited to desired video clip length, transition effects between clips, background music selection, overlay graphics, and text annotations, which are incorporated into the project data model to guide the rendering of the web-based user interface and a final video editing workflow.

17. A system for generating a video editing project, the system comprising:
means for selecting a set of video clips from a collection of pre-processed video clips with selection criteria received via a user interface of a web-based application, each pre-processed video clip being associated with metadata comprising text corresponding with speech, the text derived from applying a speech-to-text algorithm to an audio track of the video clip and associated with timing data indicating a temporal occurrence of the speech within the video clip;
means for generating a prompt for use as input to a generative language model, the prompt including i) a natural language instruction derived from the selection criteria that directs the generative language model to identify timing data for salient snippets relevant to the selection criteria, and ii) a context portion that includes the metadata from the selected video clips;
means for providing the generated prompt as input to the generative language model, wherein the generative language model processes the prompt and generates output comprising data for constructing a project data model, the data including timing data for salient snippets based on the timing data within the selected video clips;
means for constructing a project data model from the output of the generative language model, wherein the project data model includes references to one or more of the selected video clips and specifies a beginning point and an ending point for the salient snippets identified by the generative language model; and
means for rendering a dynamic and interactive web-based user interface that visually represents the project data model, the user interface providing a timeline view of the video editing project and enabling user interaction for editing and refining the video project based on the project data model.

18. The system of claim 17, further comprising:
means for pre-processing the video clips to include text corresponding with objects depicted in the video clips, the text derived from applying one or more computer vision algorithms to the video clips, wherein the metadata associated with each pre-processed video clip includes this text, and the generative language model utilizes the text to enhance the identification of salient snippets based on both the speech and depicted objects within the video clips.

19. The system of claim 17, wherein the natural language prompt characterizes content desirable to a user as specified in the selection criteria, the prompt comprising one or more of a topic, a theme, a subject matter, a sentiment, specific keywords or phrases, questions or answers, narrative elements, or actionable content;
wherein the generative language model identifies salient snippets from the selected video clips that correspond to the characterized content.

20. The system of claim 17, wherein the selection criteria received via the user interface further include one or more of the following: video clip tags, folder hierarchy, source-based selection, date and time filters, content analysis metrics, user engagement data, quality and resolution specifications, or custom queries, which collectively or individually contribute to the selection of the set of video clips from the collection.
